(19) United States
(12) Patent Application Publication
(10) Pub. No.: US 2009/0077594 A1
(43) Pub. Date: Mar. 19, 2009

(54) HDD-BASED COMMERCIAL AIRPLANE ENTERTAINMENT SYSTEM

(75) Inventors: Vlatko Milosevski, Eindhoven (NL); Marija Grueva Milosevska, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,598

(22) PCT Filed: Nov. 3, 2005
(86) PCT No.: PCT/IB05/53592

§ 371 Date: May 3, 2007

Related U.S. Application Data
(60) Provisional application No. 60/624,886, filed on Nov. 4, 2004.

(51) Int. Cl. H04N 7/18

(52) U.S. Cl. 725/76

(57) ABSTRACT

A system and method for providing a passenger's preferred content in a transportation unit are provided. A user computer (6) in communication with a server (2) over a network (4) provides the uploading of personal content, and the loaded personal content is transferred to the transportation unit for a subsequent replay.

The present invention relates to airplane entertainment systems. More particularly, the present invention relates to an entertainment system and method for providing audio/video contents that match the passenger's preference.

All commercial airlines have in-flight entertainment systems in their airplanes. Nowadays, small flat TV screens are available for each passenger to select and watch pre-defined programs and games via several channels. However, the offered audio/video or game contents often do not match the passenger's taste. Moreover, the entertainment contents do not change frequently, so for frequent fliers most of the programs have already been seen or heard or are not desired. Therefore, there is a need for improvement of the service offered to the traveler that allows each passenger to bring his/her own content for enjoyment during the flight.

The present invention provides a system and method for providing one's own content during the flight. The system includes a network, a user computer coupled to the network for requesting the uploading of personal content, and a server coupled to the network. The server provides a graphical user interface having a list of instructions associated with the verification of the passenger and the loading of personal content. Prior to departure, passengers may visit the airline's website on the Internet from a personal computer to upload the desired personal contents. The server loads the personal contents from a passenger or a group of passengers in a predetermined space in its memory, which will be connected or transmitted into the airplane's in-flight entertainment system. Using the flat TV screen and a graphical user-interface control system provided in the airplane, each passenger may selectively enjoy his or her personal program contents. The passenger's contents can be distributed in a number of channels, and channel sharing between passengers is possible.

Details of the present invention, both as to its structure and operation, can best be understood by referring to the following description with reference to the accompanying drawings in which:

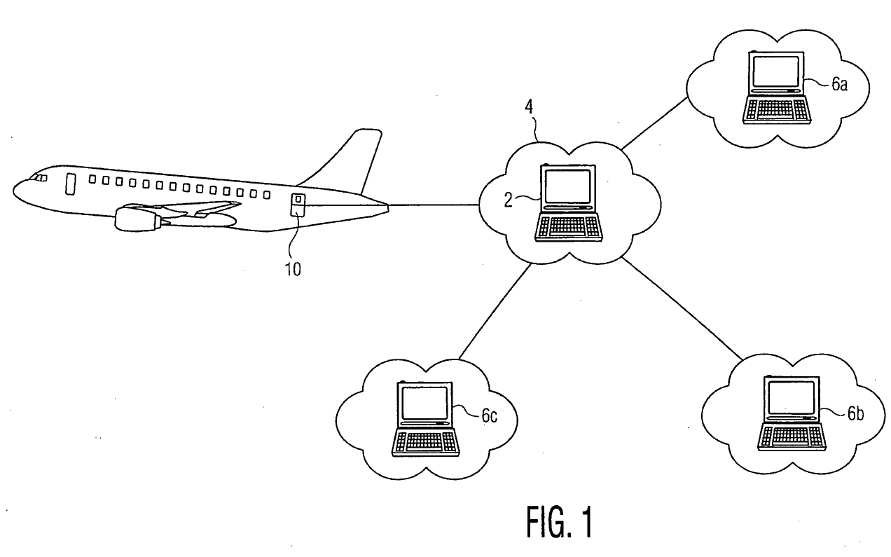

FIG. 1 is a diagram of a network in accordance with an embodiment of the present invention;

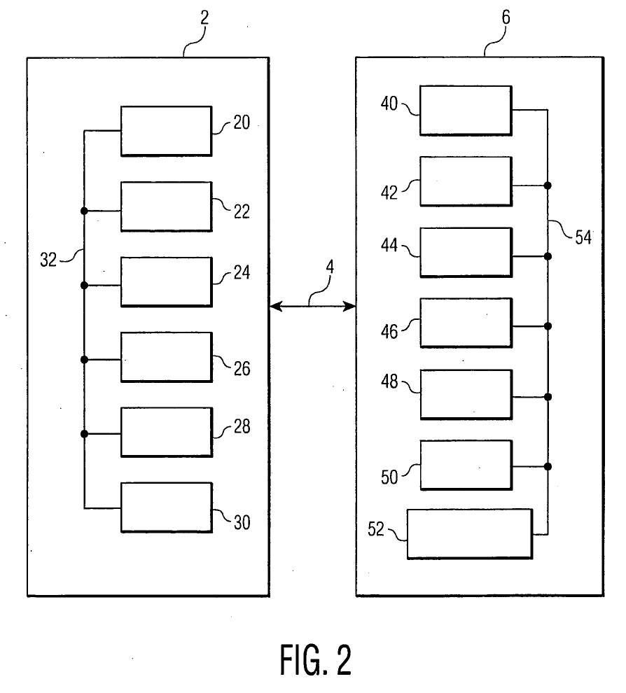

FIG. 2 is a block diagram of a server and a computer in accordance with an embodiment the present invention;

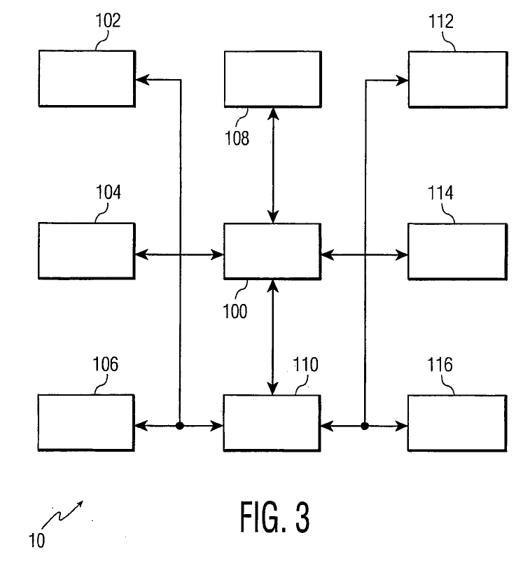

FIG. 3 is a block diagram of an in-flight entertainment system in accordance with an embodiment of the present invention;

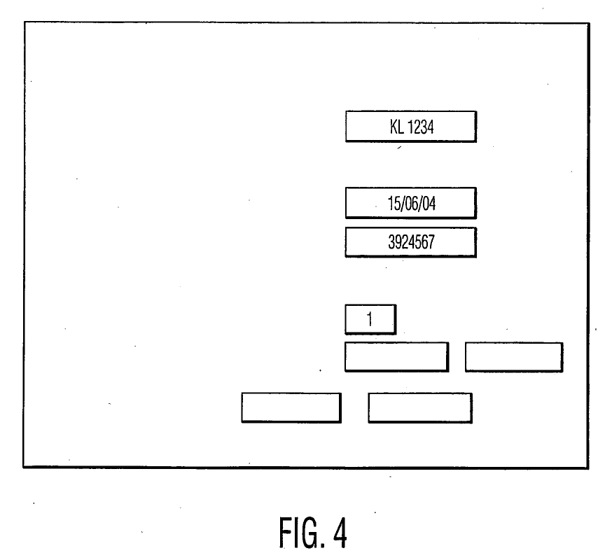

FIG. 4 is an exemplary user interface screen in accordance with an embodiment of the present invention; and

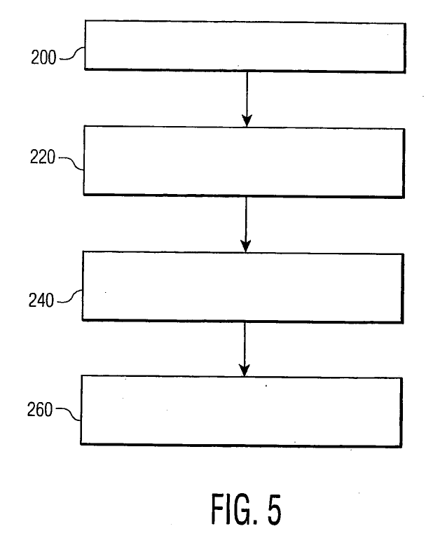

FIG. 5 is a flow chart illustrating the operation steps in accordance with an embodiment with the present invention.

The present invention is now described more fully hereinafter with reference to the accompanying drawings that show embodiments of the present invention. The present invention, however, may be embodied in many different forms and should not be construed as limited to the embodiments set forth herein. For example, although the embodiment described herein is applicable in on airplanes, the teachings of the present invention can be applied to train, boat, or auto transportation environments. Further, the computer described in the specification may be a workstation, personal digital assistant (PDA), hand-held computer, and/or any other device that manipulates digital information based on programming instructions.

FIG. 1 is a diagram of a system in accordance with the embodiment of the present invention. As shown, the system includes a server computer 2 connected over a network 4 to a plurality of computers 6 and an in-flight entertainment system 10. The computers 6 may communicate with server 2 over network 4. Network 4 allows, but is not limited to, communication between computers 6 and server 2. In the embodiment, network 4 may be a Wide Area Network (WAN), such as the Internet. In an alternative embodiment, network 4 is a Local Area Network (LAN) such as the Intranet. The network 4 is coupled to computers 6a-6n having browser programs respectively.

Referring to FIG. 2, the server 2 implements, but is not limited to, the methods of the present invention and includes components, such as a central processing unit (CPU) 20, connected by a bus 32 to memory 30, a database 22, read only memory (ROM) 24, random access memory 26, network interface 28, and memory 30. CPU 20 is a microprocessor, such as an INTEL PENTIUM® processor, but it may be any processor that executes program instructions in order to carry out the functions of the present invention. CPU 20 and various other components of the server 2 communicate through a system bus 32 or similar architecture. CPU 20 connects to database 22 using systems bus 32. The network interface 28 enables the data contained in data database 22 to transmit over network 4 under the direction of CPU. Alternatively, the data from the server 2 can be plugged into the entertainment system 10 directly. The database 22 may include hard disks, CD-ROMs, floppy disks, optical storage devices, magnetic storage devices, etc. The memory 30 stores may include a code, such as computer program instructions that may be executed by CPU 20. In the preferred embodiment, an entertainment program routine is loaded into the memory 30 and performs the functions, as described in detail hereinafter, implemented by the present invention as illustrated in FIG. 5.

Similarly, computers 6 may include components, such as a central processing unit (CPU) 40, connected by a bus 54 to the memory 42; a read only memory (ROM) 44; random access memory (RAM) 46; network interface card 48, which is connected to network 4 for communication with server 2. The computers 6 may also include interfaces, such as display interface 50 and input interface 52. The display interface 50 enables the display of information, such as passenger verification and personal-content loading information. Input interface 52 enables the manipulation of information, such as selecting information displayed on display interface 52 and the loading of personal contents. The memory 42 stores data, such as the Browser Program and operating system. The Browser Program includes a code, such as computer program instructions executed by CPU 40 to enable the information content available at server 2 to be provided to computer device 6 in a manner that can be understood by a user. The browser serves as a front end to the World Wide Web on the Internet and is designed to display one web page at a time.

Referring to FIG. 3, an in-flight entertainment system 10 in accordance with an embodiment of the present invention includes an input interface 102, database 104 containing the personal program content of passengers such as a plurality of MP3 file bit streams, MPEG-2 encoded video information content, or MPEG-1 layer audio content, video output 106, ROM 108, CPU 100 for controlling all the functions of the elements in the system 10, D/A converter 110, RAM 112, memory 114, and audio output 116. The D/A converter 110 is provided for converting the digital MP3 file signal output into an analog signal and outputting the converted analog signal to the video output 106, such as flat display and audio output device 116, such as a speaker or a headphone set.

Referring to FIG. 5, a passenger first interacts with a computer 6 to access a World Wide Web Internet site and, more particularly, an airline website in step 200. As shown in FIG. 4, the passenger inputs necessary information, such as the flight number, flight date, name and/or passenger ID code. After the flight number is found and the passenger is verified, the passenger can select a channel and upload the personal audio/video content (e.g., DVD, DivX, MP3, games, etc.) on the hard-disk drive (HDD) of the airplane server in step 220. This enables the HDD to be loaded with collective personal contents of all flight passengers, then to be transmitted or taken to the airplane and plugged into the airplane's entertainment system 10 in step 240.

During the flight, in step 260, the control panel of each passenger's seat will allow the passenger to go through the pre-recorded contents for replay. Each set is provided with a display and a user-interface means, such as a cursor control device or a keyboard, through which the passenger can browse or otherwise interact with the personal information content. Here, the control panel of a passenger's can be automatically configured to the passenger's own play-list, thus showing each topic on the flat screen. Access may be provided through selection using input interface. Alternatively, a touch screen may be implemented to initiate the audio/video programs. In case the passenger is traveling with others, channel sharing may be possible by allowing the channel to be shared by the same parties or with other passengers on the airplane.

Although specific embodiments of the present invention have been described, it will be understood by those skilled in the art that there are other embodiments that are equivalent to the described embodiments. Accordingly, it is to be understood that the invention is not to be limited by the specific illustrated embodiments, but only be the scope of the appended claims.

1. A method of providing a personal content in a mobile unit, the method comprising the steps of:
uploading the personal content of an individual to a remote server (2) over a network (4);
transferring the uploaded personal content to an entertainment system (10) of the mobile unit; and,
providing a graphical interface having a list of topics associated with the personal content.

2. The method of claim 1, further comprising the steps of identifying the individual and, upon identification, enabling the uploading of the personal content to a memory (104) of the remote server (2).

3. The method of claim 1, wherein transferring of the uploaded personal content to the entertainment system (10) is achieved via a wireless transmission.

4. The method of claim 1, wherein the personal content is stored in a predefined memory space (22) of the remote server (2) and then physically transferred to the entertainment system (10).

5. The method of claim 1, wherein the mobile unit is one of airplane, boat, automobile, and train.

6. The method of claim 1, wherein the network is the Internet or the Intranet.

7. The method of claim 1, wherein the personal content is one of audio, video, and game.

8. A system for providing a personal content in a mobile unit, comprising:
a network (4);
a remote server (2) coupled to the network (4); and,
a user computer (6) coupled to the network (4) for uploading the personal content of an individual of the remote server (2), wherein the uploaded personal content is transferred to an entertainment device (10) of the mobile unit for a subsequent replay.

9. The system according to claim 8, further comprising:
an audio replay device provided in the mobile unit for permitting the individual to listen to an audio program.

10. The system according to claim 8, further comprising:
a video replay device provided in the mobile unit for permitting the individual to view an video program.

11. The system according to claim 8, wherein the entertainment device (10) further comprising a display unit for providing a graphical interface having a list of topics associated with the personal content.

12. The system according to claim 8, wherein the uploaded personal content is transferred to the entertainment device (10) via a wireless transmission.

13. The system according to claim 8, wherein the personal content is stored in a predefined memory space (22) of the remote server (2) and then physically transferred to be provided in the entertainment device (10).

14. The system according to claim 8, wherein the mobile unit is one of airplane, boat, automobile, and train.

15. The system according to claim 8, wherein the network (4) is the Internet or the Intranet.

16. An apparatus for providing a personal content in a mobile unit, comprising:
a processor;
a memory, coupled to said processor, said memory being configured to allow the processor to:
upload the personal content of an individual to a remote server;
transfer the uploaded personal content from the remote server (2) to an entertainment system (10) of the mobile unit; and,
selectively reply the uploaded personal content.

17. The apparatus according to claim 16, wherein said memory is further configured to allow said processor to verify the identify of the individual.

18. The apparatus according to claim 16, wherein said memory is further configured to allow said processor the to provide a list of topics associated with the personal content to the passenger.

19. The apparatus according to claim 16, wherein the mobile unit is one of airplane, boat, automobile, and train.

20. The apparatus according to claim 16, wherein the personal content is one of audio, video, and game.
